(19) United States
(12) Patent Application Publication
(10) Pub. No.: US 2009/0134096 A1
(43) Pub. Date: May 28, 2009

(54) Submersible reservoir management system

(76) Inventors: Amir Ali Giti, Redondo Beach, CA (US); Earl Ahrens, Rancho Palos Verders, CA (US)

Correspondence Address: Jo Katherine D'Ambrosio;D'Ambrosio & Associates, P.L.L.C., Suite 465, 10260 Westheimer Road, Houston, TX, 77042, US

(21) Appl. No.: 12/315,294

(22) Filed: Dec. 2, 2008

Related U.S. Application Data
(62) Division of application No. 11/637,994, filed on Dec. 13, 2006.
Application No. 11/637,994 is a continuation-in-part of application No. PCT/US2004/018802, filed on Jun. 14, 2004.

(51) Int. Cl. C02F 9/08; C02F 103/00

(52) U.S. Cl. 210/742

(57) ABSTRACT

A method for submerging a submersible reservoir management system for large water reservoirs to circulate the water, monitor and add chemicals to the water and reduce temperature gradients. The method comprises locating a submersible Pump assembly in the reservoir, the assembly comprising one or more pumps, one or more jet mixers and a frame. The reservoir management system is analyzed for chemical content, and the submersible pump assembly adds disinfecting chemical when necessary to control water quality. A jet stream is produced to provide circulation of the chemicals and temperature uniformity within the reservoir. The reservoir management system can be repositioned both vertically and horizontally.

### CROSS REFERENCE TO RELATED APPLICATIONS

This application is a divisional application of U.S. application Ser. No. 11/637,994 filed Dec. 13, 2006, which is a continuation-in-part of PCT/published application WO 2006/001800 A1, International Application No. PCT/US2004/018802, filed on 14 Jun. 2004.

### FIELD OF THE INVENTION

The present invention relates to a method for submerging a reservoir management system, more particularly, to a method for positioning a reservoir management system that controls water impurity level and maintains temperature uniformity within a large water reservoir.

### BACKGROUND OF THE INVENTION

Large water-containing reservoirs require management of temperature gradients and microbe development to ensure high quality water for dispensing to municipalities and the like. Because of their size, these reservoirs have a problem with water at or near its surface that can become warmer during the summer, particularly in temperate zones. Make-up water usually is colder and, while it may reduce the temperature, is not very effective and instead make-up water can short-circuit the retained water in the reservoir. Temperature gradients produced by ineffective mixing of disinfectant chemicals result. Because the bodies of water are so large both in width and depth, even with a reservoir management system in place, regulation of temperature and the addition of chemicals is often uneven. Stagnation and stratification can occur, because of the limited area, both below and above the surface, that is circulated by existing reservoir management systems. Circulation of make-up water and added chemicals throughout the reservoir is spotty and limited, resulting in inconsistent water quality.

### SUMMARY

Floating pumps and pumps that are partially submersible do not resolve the problem of stratification of temperature and uneven distribution of chemicals throughout the reservoir. Existing submersible reservoir management systems have an additional problem of maintaining stability at greater depths. Special problems occur in earthquake prone areas. Certain districts, California for example, have government requirements which provide for stringent seismic requirements that affect the use of submersibles. Consequently, it appears that there is a need for a system that provides for uniform disinfection and maintains uniformity in temperature by effective re-circulation of stratified waters within the reservoir.

The submersible reservoir management system for large water reservoirs of the present application comprises a submersible pump assembly comprising a submersible pump and a frame that is removably attached to the pump. The frame supports and stabilizes the pump when it is submerged, even when resting on the bottom of the reservoir. In one embodiment of this invention, one or more ballast tanks are mounted onto the frame. Water is used as the ballast. As air is exhausted from the ballast tanks and replaced by water, the pump submerges within the reservoir. The ballast tanks comprise one or more air hoses, one or more water inlets and one or more water outlets. The frame comprises a tripod, the tripod having a bracing means to support the submersible reservoir management system. Alternatively, the frame comprises a base, the base of the frame providing a more stable support, if needed, as the reservoir management system rests on the bottom of the reservoir. The frame allows the submersible pump to move horizontally throughout the reservoir, so that the pump, which is a recirculating pump, can provide improved mixing of chemicals and reduce temperature gradients within the reservoir. The addition of the ballast tanks allows for vertical positioning of the submersible pump, further improving circulation of chemicals and heat throughout the reservoir. The improved circulation avoids temperature stratification and stagnation that is problematic in typical large reservoirs.

In one aspect of the submersible reservoir management system, the submersible pump assembly comprises one or more submersible pumps and one or more jet mixers for mixing and circulating water. The assembly is connected to a means for analyzing reservoir water for chemical content and means for adding chemicals. One embodiment of the system comprises a frame. The frame comprises a base that is rectangular and four struts, each strut having a base end and a mounting plate end, each base end connected to a corner of the base and each mounting plate end securely attached to the mounting plate. The mounting plate further comprises one or more flanges, and the four struts are attached to the one or more flanges of the mounting plate. In an alternative embodiment, the frame comprises a tripod. The tripod comprises legs angled to attach to the pump and provide a lighter weight frame system for supporting the submersible pump assembly on the floor of the reservoir. Preferably, a bracing means is also used to attach and brace the legs of the tripod to the pump system.

In one embodiment, the mounting plate and its one or more flanges are smaller than the base, so that the struts angle inward from the base to the mounting plate. The reservoir management system is positioned between the ballast tanks to stabilize the system. One or more bands are used to secure the submersible pump to the mounting plate. In one embodiment, the bands comprise u-bolts. One or more trusses are used to secure the one or more ballast tanks to the mounting plate.

In one embodiment, the submersible pump comprises means to produce a jet of water therefrom within the water reservoir and means to ingest water from the reservoir at a point remote from the jet. The jet mixer can be positioned in the jet of water to draw low pressure water surrounding the jet mixer and to discharge a stream of water therefrom to mix and circulate the water within the reservoir and to remove temperature gradients in the body of water. The submersible pump further comprises a means for adding at least one of ammonia, hypochlorite, and chlorine to the body of water, the means designed to add one of the ammonia, hypochlorite, and chlorine to the stream of water discharging from the pump or the jet mixer, means for removing a test stream of water from the reservoir on a continuous basis, the means designed to remove the test stream remote from the water discharging from the jet mixer. In this embodiment, the system is connected to an analyzer for determining the level of at least one of chlorine and chloramine in the test stream to provide a chlorine or chloramine related signal. A controller is designed to receive the signal and to compare the signal to a set point indicative of the level of chlorine or chloramine desired in the reservoir water to provide a comparison. In response to the comparison, the controller maintains, increases, or decreases the amount of ammonia, hypochlorite, or chlorine added to the body of water in the reservoir.

In one method for submerging a reservoir management system for water reservoirs to circulate the water, monitor and add chemicals to the water and reduce temperature gradients, the method comprises locating a submersible pump in the reservoir. This preferred method comprises a reservoir management system having a submersible pump assembly that is securely mounted to a frame in a position for optimum stabilization. In one embodiment of this method, the frame preferably has a base, a support mounting plate and one or more struts connecting the base to the support mounting plate. In this embodiment, the frame further comprises an inner control area and the reservoir management system is positioned within this control area. In one aspect of the invention, a submersible pump is attached onto the support mounting plate within the inner central area for improved stabilization. One or more flanges are attached perpendicular to the mounting plate and the submersible pump is positioned between the arms of the flanges. Alternatively, the frame comprises a tripod. The legs of the tripod provide stability as the submersible pump floats and supports the submersible pump when the reservoir management system is at rest on the floor of the reservoir.

In one embodiment of this invention, one or more ballast tanks are attached to the submersible pump assembly. The pump can be operated in one location and then repositioned vertically within the reservoir by increasing or decreasing the ballast within the one or more ballast tanks to provide mixing action within the reservoir so as to diminish temperature gradients within water contained in the reservoir and to efficiently mix chemicals added thereto for treatment purposes. Repositioning the reservoir management system horizontally within the reservoir is accomplished manually or by motorized vehicles.

### BRIEF DESCRIPTION OF THE DRAWINGS

FIG. 1 is a three dimensional view of one embodiment of the submersible reservoir management system of this invention.

FIG. 2 is a cross-sectional view of the submersible pump.

FIG. 3 is a schematic of another embodiment of a reservoir management system.

FIG. 4 is a three dimensional view of still another embodiment of the reservoir management system.

### DETAILED DESCRIPTION

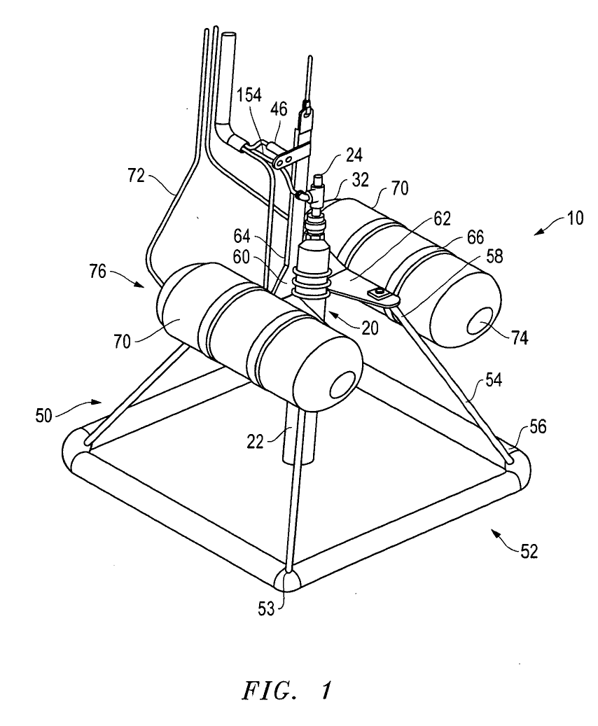

As illustrated in FIG. 1, the submersible reservoir management system 10 for water reservoirs of the present application comprises a submersible pump assembly 20 having a frame 50 that provides stability both as the pump assembly 20 is floating through the water and when it rests on the bottom of the reservoir. Reservoir management systems 10 are used to control the chemical disinfectant content within the reservoir to avoid stagnation and to circulate the water to reduce temperature stratification. One or more pumps 22 can be operated in one location and then repositioned horizontally within the reservoir by moving the frame 50 manually or with motorized vehicles. The pump 22 is repositioned to improve circulation so as to diminish temperature gradients within water contained in the reservoir and more efficient mixing of chemicals added thereto for treatment purposes.

Vertical movement occurs with the use of one or more ballast tanks 70, because increasing or decreasing the ballast within one or more ballast tanks will cause the lowering or raising of the submersible pump assembly within the reservoir. In one embodiment, the one or more submersible ballast tanks 70 are mounted onto the submersible pump assembly on either side of the pump with the submersible pump 22 positioned in the middle. Water is used as the ballast. As air is exhausted from the ballast tanks 70 and replaced by water, the submersible pump 22 submerges within the reservoir 100. The ballast tanks 70 comprise one or more air hoses 72 attached to an air pump (not shown) for pumping air into the tanks 70 to raise up the assembly 20 and one or more water inlets 74 and one or more water outlets 76 used when ballast is required to lower the system. The ballast tanks 70 comprise high density linear polyethylene.

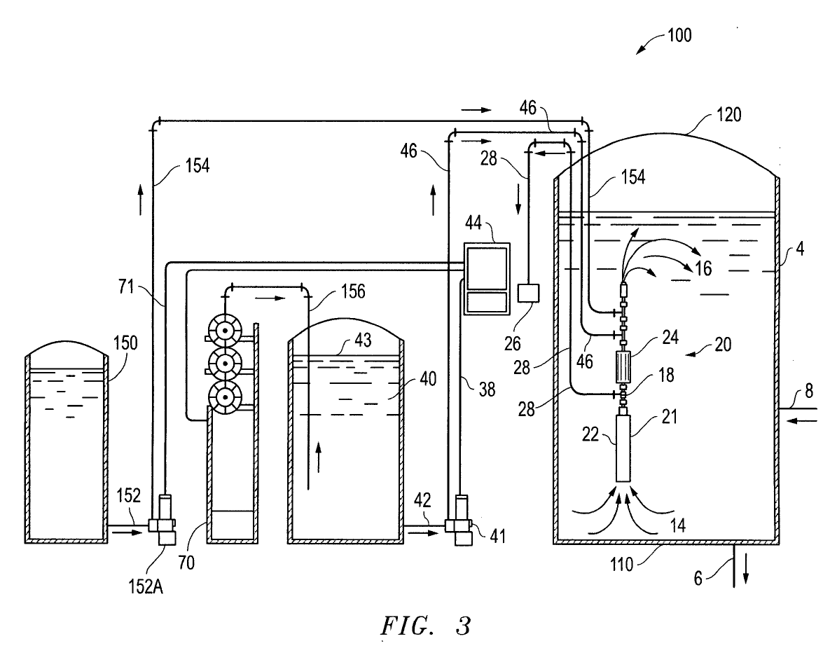

As shown in FIG. 1, the submersible reservoir management system 10 comprises a submersible pump assembly having a submersible pump 22 and a jet mixer 24 in communication with the pump for mixing and circulating water. In alternate embodiments, the pump assembly 20 can comprise one or more submersible pumps 22 and one or more jet mixers 24. For simplicity, one pump and one jet mixer will be used to describe the embodiment in this detailed description of the invention. The submersible pump 22 is attached to a means for analyzing reservoir water for chemical content shown as an analyzer 26 (FIG. 3) and means for adding chemicals, such as lines 46, 154, when necessary. In one embodiment of this invention, the frame 50 supports the submersible pump 22 and the ballast tanks 70, all of which are securely attached to the frame 50 to prevent slippage.

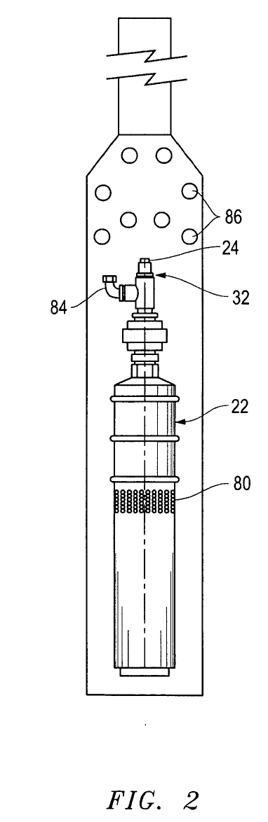

Referring to FIGS. 2 and 3, the one or more submersible pumps 22 have a perforated water intake 80 and an injection nozzle exit 32. A water sample line 28 may be connected to a coupling 84 for purposes of continuously removing a water sample, which is forwarded or directed to chemical analyzer 26. The water jet emanating from nozzle exit 32 is used to power the jet mixer 24. Holes or apertures 86 in the mounting plate 60 for the pump 22 are used to accommodate chemical dosing lines 154 and 46 which can be located below or above the jet mixer 24. For most applications, a 1 HP stainless steel submersible pump is suitable. A jet mixer useful with a 1 HP pump can provide about five times the flow or about 50 gpm. Typically, the pump assembly 20 is mounted in a generally vertical direction within approximately about 10 feet above the bottom of the tank.

In one embodiment, the submersible pump 22 is used in combination with jet mixer 24 (also known as an eductor) as illustrated in FIGS. 1, 2 and the schematic of FIG. 3. This combination has the effect of providing more efficient mixing in large reservoirs. That is, the use of jet mixer 24 improves mixing by moving or utilizing 3 to 5 more volumes of water in the reservoir. Thus, this has the advantage of providing for superior mixing of disinfectants or chemicals and in addition provides for more uniformity of temperature within reservoir 100 and avoidance of stagnation. The jet mixer 24 provides additional mixing by using a jet 18 of water that is discharged from the pump nozzle 32 which is at a higher pressure than water surrounding the nozzle 32. That is, the jet of water 18 from the submersible pump 22 acts as the pumping fluid in the jet mixer 24. As the jet of water passes through a venturi in the jet mixer 24, it develops a suction which causes some of the surrounding water to be taken into the jet mixer 24 and entrained with jet 18, causing further or additional mixing in the reservoir in the stream 16 emerging from the mixer 24. For example, if the rate of water emerging from the pump nozzle 32 is 5 gal./min., the action of the jet mixer 24 increases the rate of water emerging from it to 125 gal./min.

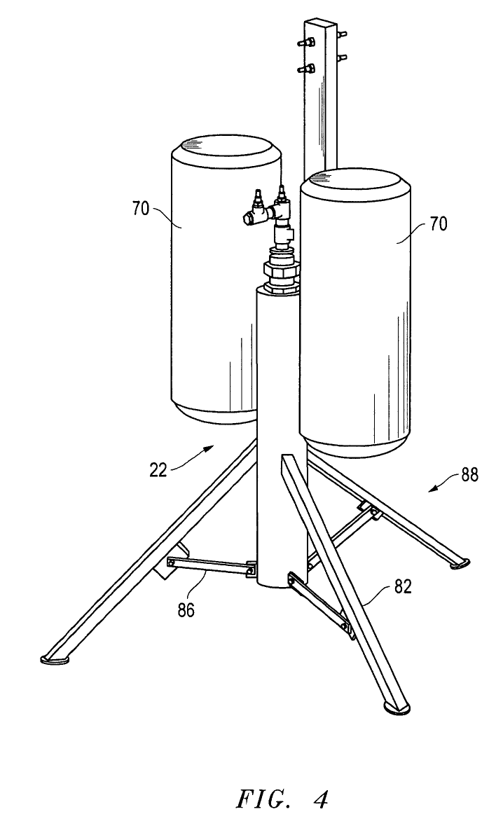

Referring to FIGS. 1 and 4, the submersible pump assembly 20 comprises a frame 50, 88. In one embodiment, the frame 88 is a tripod and the legs 82 of the tripod support the pump 22 when resting or moving on the bottom of the reservoir. The legs 82 of the tripod each have one end that is securely and rotably attached to the pump 22. The other end of each leg is adapted to lie on the floor of the reservoir. In one embodiment, the tripod frame 88 comprises bracing means which also are rotably attached to the pump 22 to brace and further support the pump 22 within the frame 88.

Referring to FIG. 1, in another embodiment, the frame 50 comprises a base 52 that is preferably rectangular to provide stability, support struts 54 and a mounting plate 60 to which the struts 54, submersible pump 22 and ballast tanks 70 are attached.

The frame 50 supports and stabilizes the pump 22 as it is submerging, moving throughout the reservoir or resting on the bottom of the reservoir. In one embodiment, the pump 22 is positioned within the frame 50 for optimum stability. It maintains a vertical alignment as it is being moved within the reservoir or during seismic upsets such as earthquakes that are problematic in certain geographic areas. In one embodiment, all parts of the frame are comprised of stainless steel for durability and weight.

The heavy base 52 forms the bottom of the frame 50 for stabilizing the reservoir management system and supporting the reservoir management system when the base 52 is positioned on the bottom of the reservoir. The base 52, made from stainless steel, is approximately 2 inches in width and heavy enough to weigh down the submersible pump assembly 20 within the reservoir so it does not sway or move about undesirably. In one embodiment, the base comprises wheels to facilitate movement on land, prior to placing the submersible reservoir management system 10 into the reservoir.

In one aspect of the invention, the frame 50 comprises four struts 54, each strut 54 having a base end 56 and a mounting plate end 58. Each base end 56 is connected to a corner 53 of the base and each mounting plate end 58 is securely attached to the mounting plate 60. The mounting plate 60 further comprises one or more flanges 62 perpendicular to the plate 60 and the four struts 54 attached to the one or more flanges 62.

As illustrated in FIG. 1, the width of the mounting plate 60 is considerably smaller than the base 52 so that the struts 54 angle inward from the base 52 to the mounting plate 60. This configuration, along with the weight of the base, provides stability to the submerged reservoir management system 10. The one or more submersible pumps 22 and one or more jet mixers 24, are securely attached to the mounting plate 60 between the ballast tanks 70 to further stabilize the system. One or more bands 64 are used to secure the submersible pump 22 to the mounting plate 60. In one aspect of the invention, the bands 64 comprise u-bolts. One or more trusses 66 are used to secure the one or more ballast tanks 70 to the mounting plate 60.

As illustrated in FIGS. 1, 3 and 4, the reservoir management system 10 of the present invention comprises one or more pumps 22 encased within a frame 50, 80 that is submergible within the reservoir 100 until a base 52, of the frame 50 rests or is moved along the bottom 110.

As noted previously, a problem with large reservoirs is that water in the reservoirs becomes warm, particularly in hot climates. Make-up water introduced to the reservoir usually is colder and, without recirculation, leaves warmed areas that can result in the retained water becoming stagnant and generally unsuitable for use. FIG. 3 is a schematic illustrating a method and system for submerging a reservoir management system to maintain a reservoir substantially free of temperature gradients and also to maintain the body of water under high quality conditions suitable for the end users. Water is dispensed from reservoir 100 along line 6 and added to reservoir 100 along line 8. In one embodiment, water is dispensed from the bottom of the reservoir 110 to utilize pressure. Submerging the reservoir management system to the depths of the reservoir increases the circulation of water for a more homogenous mixing of chemicals and water temperature. The submersible pump 22 stirs or mixes the water contained in the reservoir 100. In operation, the submersible pump 22 ingests water at the lower portion or bottom 21 from adjacent the reservoir bottom 110 as illustrated by water flow arrows 14 and discharges a jet 18 of water by means of nozzles 32 (shown in FIG. 2).

The submersible reservoir management system 10 of this invention may be easily retrofitted within a reservoir 100 since no permanent attachments are required. Reservoirs 100 are typically fitted with a top 120, in some cases, a floating top. Prior reservoir management systems suspended the submersible pump 22 and jet mixer 24 by a strut attached to the pump 22. Rippling seismic waves or earthquakes, sometimes having in excess of 30,000 lbs. of force, can severely damage both the reservoir top 120 and submersible pump 22. As illustrated in FIGS. 1 and 4, the submergible reservoir management system 10 of this invention is free from the reservoir itself and stabilized by the frame 50, 80 and, when attached to the submersible pump assembly, the ballasts 70. It reduces the requirement of seismic restraints for the submersible pump assembly 20.

In another embodiment of the invention, the chemistry of the water in the reservoir is maintained by continuous sampling of the water and adjusting the amount of chemicals such as ammonia and chlorine-containing materials such as chlorine gas, chlorite, chlorine dioxide and hypochlorite added thereto. As illustrated in FIG. 3, a small stream of water is removed from the reservoir on a continuous basis along line 28 to a water analyzer 26 where the amount of free chlorine and total chlorine are measured. These measurements may be used to generate chlorine or chloramine-related measurement signals which are electrically communicated to a controller 44 such as programmable logic controller (PLC). The controller 44 is adapted to compare the chlorine or chloramine-related measurement signals with a set point; the controller 44 determines whether the amount of chlorine in the water should be maintained, or should be adjusted upwardly or downwardly.

In one aspect of the invention, the amount of chlorine and chloramine in the water is controlled by addition of chlorine or a chlorine-containing compound such as hypochlorite and ammonia. Typically, free chlorine and chloramines are maintained in the range of 0.01 to 10 ppm in the reservoir. Referring to FIG. 3, hypochlorite such as sodium hypochlorite, is added from a source or supply 40. Sodium hypochlorite solution is added along line 42 to pump 41 and is directed along line 46 to the reservoir 100. In one embodiment, the sodium hypochlorite is added above the jet mixer 24 for purposes of more efficient mixing with the water from jet mixer 24 and distribution throughout the water.

If the determination is made by the PLC 44 that the level of chloramines are high compared to chlorine in the water, this indicates that sodium hypochlorite is required to be added. Thus, the PLC 44 sends a signal along line 38 to pump 41 to increase the amount of sodium hypochlorite solution being added to the reservoir. It will be appreciated that PLC 44 can be programmed to calculate the amount of sodium hypochlorite to be introduced to the reservoir for correction purposes. Further, if sodium hypochlorite is already being added, PLC 44 can be programmed to calculate the additional amount of sodium hypochlorite to be introduced to the water in the reservoir.

If the determination is made by analyzer 26 and PLC 44 that the level of chlorine is high compared to chloramines, this indicates that ammonia is low in the reservoir water and that ammonia should be added. Or, if the determination is made that the correct amount of ammonia is being added, the amount of sodium hypochlorite may be reduced and accordingly the PLC 44 sends the required signal to reduce the amount of sodium hypochlorite being added. If the determination is made that the amount of ammonia being added is too low, programmable logic controller 44 sends a signal along line 46 to pump 48 to increase the amount of ammonia to be added. Accordingly, ammonia is added from the ammonia storage tank 150 along line 152 and then along line 154 to water in the reservoir. In one embodiment, the ammonia is added after the water is discharged from jet mixer or mixer 24 to facilitate mixing in the water. As noted earlier with respect to sodium hypochlorite, the PLC 44 can be programmed to calculate the additional amount of ammonia to be introduced to the reservoir for correction purposes.

If the correct amount of sodium hypochlorite is being added, and the ammonia is high, then PLC 44 can signal the adjustment to pump 48 to reduce the amount of ammonia being added in order to have the required balance of chlorine and chloramine in the water being treated. It will be appreciated that the impurities in make-up water being added to reservoir 100 can change from time to time depending on the seasons, and the current system automatically adjusts for changes in composition of impurities in make-up or feed water. It should be noted that ammonia and hypochlorite react in the water as follows:

NH₄⁺+OCl⁻→NH₂Cl+H₂O

In one embodiment, PLC 44 continuously monitors the level of chlorine and chloramine in the water in reservoir using analyzer 26. Then, the PLC 44 calculates whether or not the correct amount of ammonia and hypochlorite is being added based in the amount present in the sample water. Continuously monitoring the water by analyzer 26 provides the PLC 44 with information about the water in the reservoir 100 and permits determination by the controller 44 whether the amount of either ammonia or hypochlorite being added is required to be increased or decreased or to remain the same.

In operation, the PLC 44 makes the comparison, using stored values in memory or logic table or any suitable control algorithm, and decides whether ammonia or hypochlorite or both need to be increased or decreased, and in response thereto, sends the appropriate signal to the pumps 48 and/or 44 to increase or decrease or maintain the amounts of chemicals being forwarded to the reservoir water. Implementation of the changes can be handled by any controller set up to analyze the data from the analyzer and forward the appropriate signals to pumps 41 and 48. Thus, the controller can be a PID or similar controller or PLC can be used.

While reference is made herein to sodium hypochlorite, it will be appreciated that any chemical or disinfectant such as potassium or calcium hypochlorite, liquid hypochlorite, gaseous chlorine or ammonia can be used. The sodium hypochlorite can be supplied in bulk and mixed to provide the desired concentration or the sodium hypochlorite can be generated on site as needed by a hypochlorite generator 70 and supplied to tank or supply 40. That is, PLC 44 can be set to monitor the level of sodium hypochlorite in tank 40. When PLC 44 detects that level 43 has reached a predetermined level, it sends a signal along line 71 to sodium hypochlorite generator 70 to supply sodium hypochlorite solution to tank 40 along line 56 until level 43 reaches a predetermined level wherein PLC 44 sends another signal, switching off the hypochlorite generator 70.

Further, while any method of supplying hypochlorite to tank 40 may be used, one method is disclosed in U.S. Pat. No. 6,805,787, filed Sep. 7, 2001, entitled “Method and System for Generating Hypochlorite”. In this method for producing sodium hypochlorite, a brine solution is provided for electrolyzing in a first electrolyzer cell and chilled water is added to the brine solution to provide a chilled brine solution which is then added to the electrolyzer cell and subjected for electrolyzing to produce a first hypochlorite and brine solution which has an increase in temperature. To the hypochlorite and brine solution from the first cell is added additional chilled water to lower the temperature of first hypochlorite and brine solution which is added to a second electrolyzing cell and subjected to electrolyzing, thereby increasing the amount of sodium hypochlorite to this second solution of sodium hypochlorite and brine solution.

Chilled water is added to the second solution of sodium hypochlorite and brine and the chilled solution is added to a third electrolyzer cell and electrolyzed to further provide sodium hypochlorite in the brine solution. This process is repeated one or more times until the hypochlorite and brine solution passes through all the cells in the electrolyzer assembly. The chilled water added may first be subjected to water softening to remove hardness from the water.

As illustrated in FIG. 3, ammonia is supplied from ammonia storage tank 150 on demand as controlled by PLC 44. Any source of ammonia can be employed. In one embodiment, ammonia containment system is designed to hold aqueous ammonia at atmospheric pressure without the necessity of a pressurized system tankage. This is accomplished by providing a double contained insulated polyethylene storage vessel and refrigeration system whereby ammonia is maintained below 60° F., regardless of external ambient temperature. Ammonia is delivered by bulk delivery to external connections, avoiding operator exposure. In the event of refrigeration failure, ammonia solution rate of vapor discharge is limited to energy penetrating the insulated container which greatly reduces any discharges or leaks. As a precautionary measure, redundant refrigeration can be provided.

Referring to FIGS. 1 and 3, one method of this invention submerges a reservoir management system into a large water reservoir to circulate the water, monitor and add chemicals to the water and reduce temperature gradients. In this method, a submersible pump assembly 20 is located within the reservoir. The submersible assembly is “free floating” meaning that, because of its frame 50, it is not attached to any portion of the reservoir and, therefore, independent of the reservoir. In this preferred method, the submersible pump assembly 20 comprises one or more submersible pumps 22, securely mounted to a frame 50 in a position for optimum stabilization. In one embodiment, the frame 50 has a base 52, a support mounting plate 60 and one or more struts 54 connecting the base 52 to the support mounting plate 60. In this embodiment, one or more ballast tanks 70 are positioned on an outer area of the frame so that they are supported by the frame 50. The reservoir management system is then attached onto the support mounting plate 60 within an inner central area of the frame. Alternatively, as illustrated in FIG. 4, the submersible pump assembly 20 is supported by a tripod frame 80.

In operation, the submersible reservoir management system is located in the reservoir and a jet of water is discharged from the submersible pump. Water is ingested at a point remote from the discharging. One or more jet mixers 24 are positioned in communication with the submersible pump 22 and operate within the jet of water 18 exiting from the nozzle 32 of the pump 22 to pull in low pressure water adjacent the jet mixer 24. A stream of water 16 flows from the jet mixer for increasing flow within the body of water. Disinfectant chemicals are dispersed into either the jet 18 or the stream 16 for mixing in the body of water. The submersible pump assembly 20 is then repositioned both vertically and horizontally within the reservoir as desired. Vertical positioning is effected by increasing or decreasing the ballast within the one or more ballast tanks. The system is repositioned horizontally manually or by motorized vehicles. Repositioning provides circulation of the water contained within the reservoir so as to diminish temperature gradients within the water and to efficiently mix chemicals added thereto for treatment purposes.

Simultaneously with the recirculation of water within the reservoir, a test stream of water is removed from the reservoir on a continuous basis to ensure that the disinfecting chemicals being circulating are at the required levels in various areas within the reservoir. The level of the chemicals in the test stream is determined to provide a chemical measurement related signal. The signal is then relayed to a controller; within the controller, the signal is compared to a set point indicative of the level of chemical desired in the water in the reservoir to provide a comparison. In response to the comparison, the amount of chemical being added to the reservoir is maintained at its present rate, increased to an effective level or decreased.

Having described the embodiments of the invention, it is to be understood that the invention may be otherwise embodied within the scope of the appended claims.

1. A method for submerging a reservoir management system for large water reservoirs to circulate the water, monitor and add chemicals to the water and reduce temperature gradients, the method comprising:
(a) locating a submersible pump assembly in the reservoir, the submersible pump assembly comprising one or more pumps, one or more jet mixers and a frame, the pump assembly securely mounted to the frame in a position for optimum stabilization;
(b) operating the reservoir management system by analyzing the reservoir water for chemical content and, if necessary, adding chemicals;
(c) positioning the submersible pump vertically within the reservoir and continuing to operate the reservoir management system to provide mixing action within various areas within the reservoir so as to diminish temperature gradients within water contained in the reservoir and to efficiently mix chemicals added thereto for treatment purposes; and
(d) repositioning the reservoir management system horizontally and or vertically within the reservoir.

2. The method of claim 1 further comprising vertically positioning the reservoir management system within the reservoir using one or more ballast tanks.

3. The method of claim 1 wherein the frame comprises a base, a support mounting plate and one or more struts connecting the base to the support mounting plate, the base sized so that the base is larger than the support mounting plate causing the struts to angle inwardly when connecting the base to the support mounting plate.

4. The method of claim 1 wherein the frame comprises a tripod.

5. A method for submerging a reservoir management system for large water reservoirs to circulate the water, monitor and add chemicals to the water and reduce temperature gradients, the method comprising:
(a) locating a submersible pump assembly in the reservoir, the submersible pump securely mounted to a frame in a position for optimum stabilization, and positioning one or more ballast tanks on the submersible pump assembly;
(b) discharging a jet of water from the pump and ingesting water at a point remote from the discharging;
(c) operating a jet mixer in the jet of water to pull in low pressure water adjacent the jet mixer;
(d) flowing a stream of water from the jet mixer for increasing flow within the body of water;
(e) dispersing disinfectant chemicals in one of the jet or the stream for mixing in the body of water; and
(f) repositioning the submersible pump vertically within the reservoir by increasing or decreasing the ballast within the one or more ballast tanks to provide circulation of the water contained within the reservoir so as to diminish temperature gradients within the water and to mix chemicals added thereto for treatment purposes.

6. The method of claim 5 further comprising:
(a) simultaneously with the mixing, removing a test stream of water from the reservoir on a continuous basis;
(b) determining the level of the chemicals in the test stream to provide a chemical measurement related signal;
(c) relaying the signal to a controller;
(d) in the controller, comparing the signal to a set point indicative of the level of chemical desired in the water in the reservoir to provide a comparison; and
(e) in response to the comparison, maintaining, increasing or decreasing the amount of chemical being added to the reservoir.

7. The method of claim 5 wherein the frame comprises a base, a support mounting plate and one or more struts connecting the base to the support mounting plate, the base sized so that the base is larger than the support mounting plate causing the struts angle inwardly when connecting the base to the support mounting plate; the method further comprises positioning the reservoir management system within an inner central area of the frame.

8. The method of claim 5 wherein the frame comprises a tripod.

9. The method of claim 5 further comprising repositioning the submersible pump horizontally within the reservoir.

10. A method for submerging a reservoir management system for large water reservoirs to circulate the water, monitor and add chemicals to the water and reduce temperature gradients, the method comprising:
(a) locating a submersible pump assembly in the reservoir, the submersible pump securely mounted to a frame in a position for optimum stabilization, and positioning one or more ballast tanks on the submersible pump assembly;
(b) discharging a jet of water from the pump and ingesting water at a point remote from the discharging;
(c) operating a jet mixer in the jet of water to pull in low pressure water adjacent the jet mixer;
(d) flowing a stream of water from the jet mixer for increasing flow within the body of water;
(e) dispersing disinfectant chemicals in one of the jet or the stream for mixing in the body of water;
(f) repositioning the submersible pump vertically within the reservoir by increasing or decreasing the ballast within the one or more ballast tanks to provide circulation of the water contained within the reservoir so as to diminish temperature gradients within the water and to mix chemicals added thereto for treatment purposes;
(g) simultaneously with the mixing, removing a test stream of water from the reservoir on a continuous basis;
(h) determining the level of the chemicals in the test stream to provide a chemical measurement related signal;
(i) relaying the signal to a controller;
(j) in the controller, comparing the signal to a set point indicative of the level of chemical desired in the water in the reservoir to provide a comparison; and
(k) in response to the comparison, maintaining, increasing or decreasing the amount of chemical being added to the reservoir.
